(19) United States
(12) Patent Application Publication
(10) Pub. No.: US 2024/0170710 A1
(43) Pub. Date: May 23, 2024

(54) BUTTON CELL

(71) Applicant: SAMSUNG SDI CO., LTD., Yongin-si (KR)

(72) Inventor: Jongwan KIM, Yongin-si (KR)

(21) Appl. No.: 18/222,359

(22) Filed: Jul. 14, 2023

(30) Foreign Application Priority Data
Nov. 23, 2022 (KR) 10-2022-0158688

(51) Int. Cl. H01M 10/04; H01M 50/109; H01M 50/46; H01M 50/536

(52) U.S. Cl. CPC H01M 10/0427; H01M 10/0431; H01M 50/109; H01M 50/46; H01M 50/536

(57) ABSTRACT

A button cell includes: an electrode assembly including first and second electrodes and a separator therebetween; a case accommodating the electrode assembly, electrically connected to the first electrode, and having an opening exposing the electrode assembly; a cap plate coupled to at an outer periphery of the opening in the case and having a through hole exposing a central area of the opening; a terminal plate connected to the second electrode, insulatively bonded to the cap plate, and covering the through hole; an annular welded portion connecting an edge of the cap plate and a sidewall of the case; and an annular gasket inside the case along the annular welded portion and between the electrode assembly, the edge of the cap plate, and a sidewall of the case. The annular gasket has a plurality of cut portions spaced apart from each other along an inner edge thereof.

### CROSS-REFERENCE TO RELATED APPLICATION

This application claims priority to and the benefit of Korean Patent Application No. 10-2022-0158688, filed in the Korean Intellectual Property Office on Nov. 23, 2022, the entire content of which is incorporated herein by reference.

### BACKGROUND

### 1. Field

Aspects of embodiments of the present disclosure relate to a button cell.

### 2. Description of the Related Art

Generally, a rechargeable battery is a battery that is designed to be (re)charged and discharged.

Recently, as a demand for wearable devices, such as headphones, earphones, smartwatches, and body-attached medical devices using wireless communication, such as Bluetooth increases, a need for a button cell, which is a micro-sized rechargeable battery, for mounting in a wearable device is increasing.

A conventional button cell includes an electrode assembly including positive and negative electrodes and a separator positioned between the positive and negative electrodes, a case accommodating the electrode assembly, a cap plate welded to the case, and a terminal plate insulated and bonded to the cap plate.

However, in a conventional button cell, when the case including the electrode assembly and the cap plate are welded together during a manufacturing process of the button cell, the separator of the electrode assembly may be melted by the welding heat, causing a short circuit between opposite electrodes in the electrode assembly.

The above information disclosed in this Background section is for enhancement of understanding of the background of the present disclosure, and therefore, it may contain information that does not form the prior art that is already known to a person of ordinary skill in the art.

### SUMMARY

Embodiments of the present disclosure provide a button cell including an annular gasket (or ring gasket) that suppresses movement of an electrode assembly while suppressing melting of a separator in the electrode assembly due to welding heat when the case and cap plate are welded together.

In addition, embodiments of the present disclosure provide a button cell in which the electrode assembly is easily accommodated inside the case and battery capacity deterioration is reduced or minimized even when the ring gasket is included.

An embodiment of the present disclosure provides a button cell including an electrode assembly including a first electrode, a second electrode, and a separator between the first electrode and the second electrode, a case accommodating the electrode assembly, electrically connected to the first electrode, and having an opening exposing the electrode assembly, a cap plate coupled to an outer periphery of the opening in the case and having a through hole exposing a central area of the opening, a terminal plate electrically connected to the second electrode, insulatively bonded to the cap plate, and covering the through hole, an annular welded portion connecting an edge of the cap plate and a sidewall of the case, and an annular gasket inside the case, corresponding to the annular welded portion, positioned between the electrode assembly and the edge of the cap plate and between the electrode assembly and a sidewall of the case. The annular gasket has a plurality of cut portions spaced apart from each other along an inner edge thereof.

Each of the cut portions in the annular gasket may have a triangular shape.

The annular gasket may have a first extension between an upper surface of the electrode assembly and the edge of the cap plate and a second extension extending from the first extension and between a side surface of the electrode assembly and the sidewall of the case.

The cut portions may be in the first extension.

The second extension may be thinner than the first extension.

The second extension may be shorter than the first extension.

The electrode assembly may be wound to have a jelly roll shape about a winding axis, and the first electrode may protrude closer to the cap plate than the second electrode does.

The second extension may overlap the first electrode in a horizontal direction crossing the winding aix and may not overlap the second electrode.

The first electrode may be an anode, and the second electrode may be a cathode.

The button cell may further include an insulating washer between the annular gasket and the cap plate.

The insulating washer may cover an entire rear surface of the cap plate.

The button cell may further include a bonding layer between the cap plate and the terminal plate to insulatively bond the cap plate and the terminal plate.

The terminal plate may have a flange portion covering the through hole and contacting the bonding layer and a protrusion extending from the flange portion through the through hole in the cap plate.

The electrode assembly may include a first electrode tab extending from the first electrode and welded to the case, and a second electrode tab extending from the second electrode and welded to the protrusion of the terminal plate.

The case and the cap plate may have same polarity as that of the first electrode, and the terminal plate may have the same polarity as that of the second electrode.

A ratio (e.g., a height/diameter ratio) of a height to a diameter of the button cell may be 1 or less.

According to an embodiment, a button cell is provided including an annular gasket that suppresses a movement of an electrode assembly while preventing melting of a separator of the electrode assembly due to welding heat welding generated between a case and a cap plate.

In addition, a button cell easily accommodates the electrode assembly inside the case and battery capacity deterioration is reduced or minimized even when the annular gasket is included.

### BRIEF DESCRIPTION OF THE DRAWINGS

FIG. 1 illustrates a perspective view of a button cell according to an embodiment.

FIG. 2 illustrates a cross-sectional view taken along the line II-II in FIG. 1.

FIG. 3 illustrates an enlarged view of the region A in FIG. 2.

FIG. 4 illustrates a top plan view of an annular gasket of a button cell according to an embodiment.

FIG. 5 illustrates a cross-sectional view taken along the line V-V in FIG. 4.

FIG. 6 illustrates a cross-sectional view of a button cell according to another embodiment.

FIG. 7 illustrates an enlarged view of the region B in FIG. 6.

FIG. 8 illustrates a cross-sectional view of a button cell according to another embodiment.

### DETAILED DESCRIPTION

The present disclosure will be described more fully hereinafter with reference to the accompanying drawings, in which embodiments of the present disclosure are shown. As those skilled in the art would realize, the described embodiments may be modified in various different ways, all without departing from the spirit or scope of the present disclosure.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

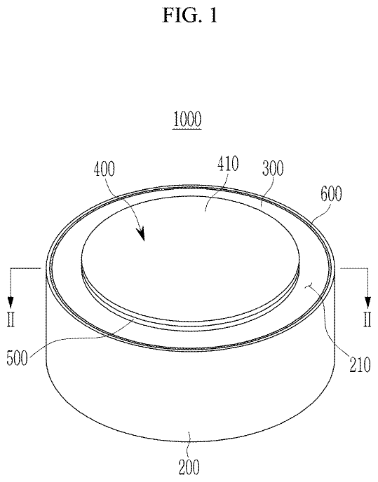

Hereinafter, a display device according to an embodiment will be described with reference to FIG. 1 to FIG. 5.

A button cell, which is a micro secondary battery, according to an embodiment, may include a coin cell, but the present disclosure is not limited thereto. The button cell, according to embodiments of the present disclosure, may include a cylindrical or pin-type battery.

Herein, the button cell, which is a battery in the form of a thin coin or button, may indicate or refer to a battery having a height-to-diameter ratio (height/diameter) of 1 or less, but the present disclosure is not limited thereto. The button cell is primarily cylindrical, so a horizontal cross-section thereof is circular, but the present disclosure is not limited thereto. In some embodiments, the horizontal cross-section may have an oval or polygonal shape. In such embodiments, a diameter may indicate or refer to a maximum distance based on a horizontal direction of the battery, and a height may indicate or refer to a maximum distance (e.g., distance from a flat bottom surface to a flat top surface) based on a vertical direction of the battery.

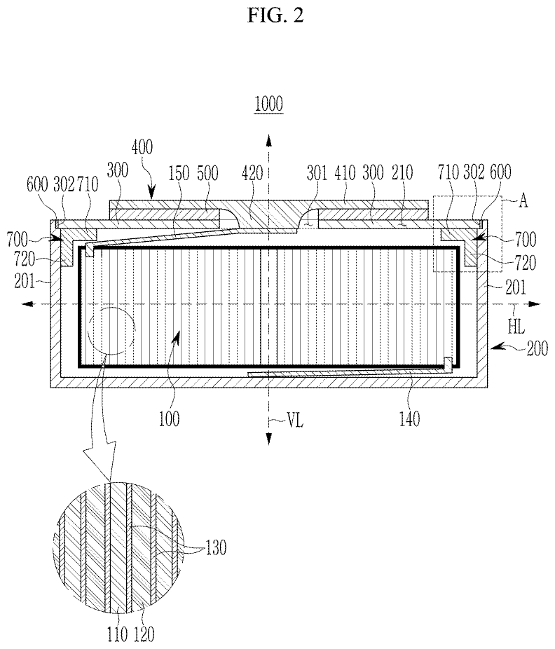

FIG. 1 illustrates a perspective view of a button cell according to an embodiment, and FIG. 2 illustrates a cross-sectional view taken along the line II-II in FIG. 1.

Referring to FIG. 1 to FIG. 2, a button cell 1000 according to an embodiment, which is a rechargeable battery designed to be charged and discharged, includes an electrode assembly 100, a case 200, a cap plate 300, a terminal plate 400, a bonding layer 500, an annular welded portion 600, and an annular gasket 700.

The electrode assembly 100 is accommodated in the case 200. A lower portion of the electrode assembly 100 faces a bottom portion of the case 200, and an upper portion of the electrode assembly 100 faces the terminal plate 400 and the cap plate 300 covering an opening 210 in the case 200. Upper and lower portions of the electrode assembly 100 may have planes parallel to each other, but the present disclosure is not limited thereto.

The electrode assembly 100 includes a first electrode 110, a second electrode 120, a separator 130, a first electrode tab 140, and a second electrode tab 150.

The first electrode 110 and the second electrode 120 are spaced apart from each other, and a separator 130 including an insulating material is positioned between the first electrode 110 and the second electrode 120. The first electrode 110 may be an anode, and the second electrode 120 may be a cathode, but the present disclosure is not limited thereto. In other embodiments, the first electrode 110 may be the cathode, and the second electrode 120 may be the anode.

The first electrode 110 has a band shape extending in a direction and includes an anode coated region, which is an area where an anode active material layer is applied to a current collector of a metal foil (e.g., a Cu foil), and an anode uncoated region, which is a region where no active material is applied. The anode uncoated region may be positioned at an end of the first electrode 110 in an extension direction.

The second electrode 120 has a band shape extending in a direction while being spaced apart from the first electrode 110 with the separator 130 provided therebetween and includes a cathode coated region, which is a region where a cathode active material layer is applied to a current collector of a metal foil (e.g., an Al foil), and a cathode uncoated region, which is a region where no active material is applied. The cathode uncoated region may be positioned at an end of the second electrode 120 in an extension direction.

The separator 130 extends in a direction between the first electrode 110 and the second electrode 120 to prevent a short circuit between the first electrode 110 and the second electrode 120.

The first electrode 110, the separator 130, and the second electrode 120 are sequentially stacked and wound to have a jelly roll shape with one vertical line VL as a center (e.g., as a winding axis) thereof, but the present disclosure is not limited thereto. The electrode assembly 100 may be formed in various known shapes. Herein, the one vertical line VL includes, but is not limited to, a virtual vertical line passing through a center of the terminal plate 400 in a vertical direction.

The first electrode 110 protrudes to be closer to the cap plate 300 and the bottom portion of the case 200 than the second electrode 120 in the direction of the vertical line VL in a state of being wound in a form of a jelly roll around one vertical line VL. When the first electrode 110 protrudes to be closer to the cap plate 300 and the bottom portion of the case 200 than the second electrode 120, a short circuit between the cap plate 300 and the case 200, which are electrically connected to the first electrode 110, and the second electrode 120 of the electrode assembly 100 may be suppressed. Each of the first electrode 110, the second electrode 120, and the separator 130 may include various known materials.

The first electrode tab 140 extends from the first electrode 110 of the electrode assembly 100 to the case 200. The first electrode tab 140 is coupled to the bottom portion of the case 200 to connect the first electrode 110 and the case 200 to each other. The first electrode tab 140 is in contact with the first electrode 110 and the case 200. The first electrode tab 140 may be welded to the bottom portion of the case 200, but the present disclosure is not limited thereto, and the first electrode tab 140 may be in contact with the bottom portion of the case 200. The case 200 and the cap plate 300 have a same polarity as that of the first electrode 110 due to the first electrode tab 140.

The second electrode tab 150 extends from the second electrode 120 of the electrode assembly 100 to the terminal plate 400. The second electrode tab 150 is coupled to a protrusion 420 of the terminal plate 400 to connect the second electrode 120 and the terminal plate 400. The second electrode tab 150 is in contact with the second electrode 120 and the terminal plate 400. The second electrode tab 150 may be welded to a surface of the protrusion 420 of the terminal plate 400, but the present disclosure is not limited thereto and may contact the surface of the protrusion 420. The terminal plate 400 has a same polarity as that of the second electrode 120 due to the second electrode tab 150.

A center pin penetrating (or extending through) a center of the electrode assembly 100 in a vertical direction may be positioned at a central portion of the electrode assembly 100, and the center pin may support the first electrode tab 140 and the second electrode tab 150, but the present disclosure is not limited thereto.

The case 200 is connected (e.g., electrically connected) to the first electrode 110 of the electrode assembly 100 and accommodates the electrode assembly 100. The case 200 has an opening 210 exposing the upper portion of the electrode assembly 100. Because the bottom portion of the case 200 is welded to the first electrode tab 140, which is connected to the first electrode 110 of the electrode assembly 100, the case 200 has a same polarity as that of the first electrode 110. The case 200 has a cylindrical can shape for accommodating the electrode assembly 100 having the form of a jelly roll, but the present disclosure is not limited thereto. In other embodiments, the case 200 may have various known shapes. The case 200 may accommodate various known electrolyte solutions together with the electrode assembly 100. An outer surface of the case 200 and an outer surface of the cap plate 300 act as a first electrode terminal of the button cell 1000, but the present disclosure is not limited thereto. In such an embodiment, an upper surface of a flange portion 410, which is an outer surface of the terminal plate 400, act as a second electrode terminal of the button cell 1000, but the present disclosure is not limited thereto. A plating layer may be coated on the outer surface of the case 200, but the present disclosure is not limited thereto, and various well-known coating layers may be coated on the outer surface of the case 200. The case 200 may include stainless steel, but the present disclosure is not limited thereto. The case 200 may include various known metals.

The opening 210 in the case 200 is covered by the cap plate 300 and the terminal plate 400.

The cap plate 300 is coupled to the case 200 along an outer area (e.g., an outer periphery) of the opening 210. The cap plate 300 has a through hole 301 exposing a central area of the opening 210. An edge 302 of the cap plate 300 is directly coupled to a sidewall 201 of the case 200 that forms the opening 210 in the case 200 by an annular welded portion 600, formed by a welding process, thereby covering an outer area of the opening 210. The cap plate 300 has a ring shape with the through hole 301 formed in the center, but the present disclosure is not limited thereto. The cap plate 300 is coupled to the case 200 by the annular welded portion 600 and has the same polarity as that of the first electrode 110. Accordingly, the cap plate 300 and the case 200 have the same polarity as that of the first electrode 110. The outer surface of the cap plate 300 may act as a first electrode terminal of the button cell 1000, but the present disclosure is not limited thereto. The cap plate 300 is insulated from and bonded to the terminal plate 400 with the bonding layer 500 provided therebetween. The cap plate 300 includes stainless steel, but the present disclosure is not limited thereto. The cap plate 300 may include various known metals.

The terminal plate 400 is connected to the second electrode 120 and is insulated from and bonded to the cap plate 300 by the bonding layer 500. The terminal plate 400 covers the through hole 301 in the cap plate 300. The terminal plate 400 is positioned on the cap plate 300. The terminal plate 400 covers a central area of the opening 210 in the case 200 exposed by the through hole 301 in the cap plate 300. Because the terminal plate 400 covers the central area of the opening 210 and the cap plate 300 covers an outer area of the opening 210, the opening 210 in the case 200 is completely covered by the terminal plate 400 and the cap plate 300. The terminal plate 400 firmly seals the electrode assembly 100 together with the case 200, the cap plate 300, and the bonding layer 500. The terminal plate 400 is coupled to the second electrode tab 150 of the electrode assembly 100 to be connected to the second electrode 120 of the electrode assembly 100. The terminal plate 400 has same polarity as that of the second electrode 120.

The terminal plate 400 includes a flange portion 410 and the protrusion 420. The flange portion 410 is positioned on the cap plate 300 and overlaps the cap plate 300 to cover the through hole 301. The flange portion 410 has a larger area than that of the protrusion 420. The flange portion 410 may have a larger diameter than that of the protrusion 420. The flange portion 410 has a thinner thickness than that of the protrusion 420, but the present disclosure is not limited thereto. A rear surface (e.g., a bottom surface) of the flange portion 410 contacts the bonding layer 500, and the flange portion 410 is insulatively bonded to the cap plate 300 by the bonding layer 500. A front surface (e.g., an upper surface) of the flange portion 410 act as a second electrode terminal of the button cell 1000.

The protrusion 420 protrudes from the flange portion 410 to extend through the through hole 301. The protrusion 420 is connected to the second electrode 120 through the through hole 301 extending from the flange portion 410. A surface of the protrusion 420 is coupled to the second electrode tab 150. The surface of the protrusion 420 may be welded to the second electrode tab 150, but the present disclosure is not limited thereto. Because the protrusion 420 is coupled to the second electrode tab 150, the protrusion 420 and the flange portion 410 of the terminal plate 400 have same polarity as that of the second electrode 120. The surface of the protrusion 420 coupled with the second electrode tab 150 may have a smaller diameter than that of a front surface of the flange portion 410, which may act as an electrode terminal. The protrusion 420 and the flange portion 410 are integrally formed using a forging process, but the present disclosure is not limited thereto. In some embodiments, different materials may be combined to form the terminal plate 400.

A plating layer may be coated on the outer surface of the terminal plate 400, but the present disclosure is not limited thereto, and various known coating layers may be coated on the outer surface of the terminal plate 400. The terminal plate 400 includes aluminum, but the present disclosure is not limited thereto. The terminal plate 400 may include various known metals.

The bonding layer 500 is positioned between the cap plate 300 and the flange portion 410 of the terminal plate 400. The bonding layer 500 insulates and bonds between the cap plate 300 and the terminal plate 400. The bonding layer 500 includes an insulating material and insulates between the cap plate 300 and the terminal plate 400. The bonding layer 500 is thermally fused between the cap plate 300 and the flange portion 410 of the terminal plate 400 by using heat or a laser beam. The bonding layer 500 includes, but is not limited to, polypropylene, polyimide, etc., and may include various known resins for insulative bonding between the cap plate 300 and the terminal plate 400. Because the bonding layer 500 bonds between the cap plate 300 and the terminal plate 400, the opening 210 in the case 200, in which the electrode assembly 100 is accommodated, is completely sealed by the cap plate 300, the terminal plate 400, and the bonding layer 500. When the terminal plate 400 is bonded to the cap plate 300 by the bonding layer 500, the cap plate 300 is welded to the case 200 in which the electrode assembly 100 is accommodated so that the case 200 and the cap plate 300 may be welded to form the annular welded portion 600.

For example, the bonding layer 500 may include a thermosetting resin and a thermoplastic resin. The thermosetting resin and the thermoplastic resin of the bonding layer 500 may be stacked to include a plurality of layers, but the present disclosure is not limited thereto. The thermosetting resin of the bonding layer 500 is in a state (e.g., may be deposited in a state) in which it can be cured by heat and may include various known thermosetting resins such as a phenol resin, a urea resin, a melamine resin, an epoxy resin, and a polyester resin. The thermoplastic resin of the bonding layer 500 includes, but is not limited to, a polypropylene resin that melts at a temperature (e.g., a predetermined temperature) and may include various known thermoplastic resins, such as polystyrene, polyethylene, and a polyvinyl chloride resin.

The annular welded portion 600 welds and couples the cap plate 300 and the case 200. The annular welded portion 600 welds between the edge 302 of the cap plate 300 and the sidewall 201 of the case 200. The annular welded portion 600 is formed between the edge 302 of the cap plate 300 and the sidewall 201 of the case 200 is welded by, for example, a laser beam. The annular welded portion 600 has a circular ring shape along a planar shape of the edge 302 of the cap plate 300 and the sidewall 201 of the case 200, but the present disclosure is not limited thereto. The annular welded portion 600 may correspond to the planar shapes of the edge 302 of the cap plate 300 and the sidewall 201 of the case 200; for example, it may have various ring shapes, such as a polygonal shape, an elliptical shape, or a closed loop shape.

The annular welded portion 600 is formed by a welding process, and when the annular welded portion 600 is formed, welding heat is generated at the annular welded portion 600. To prevent the separator 130 of the electrode assembly 100 accommodated inside the case 200 from being melted by such welding heat, the annular gasket 700 is positioned between the electrode assembly 100 and the case 200 inside the case 200 corresponding to the annular welded portion 600.

The annular gasket 700 is positioned inside the case 200 corresponding to the annular welded portion 600. The annular gasket 700 has a circular annular shape corresponding to the annular welded portion 600 in a plane view. The annular gasket 700 is positioned between the electrode assembly 100 and the edge 302 of the cap plate 300 and between the electrode assembly 100 and the sidewall 201 of the case 200. The annular gasket 700 is positioned to correspond to a corner between upper and side surfaces of the electrode assembly 100 corresponding to the annular welded portion 600. The annular gasket 700 is positioned between the corner of the electrode assembly 100 and the annular welded portion 600 inside the case 200. The annular gasket 700 may include various known insulating materials, such as polypropylene and polyimide, which have lower thermal conductivity than the case 200 and the cap plate 300.

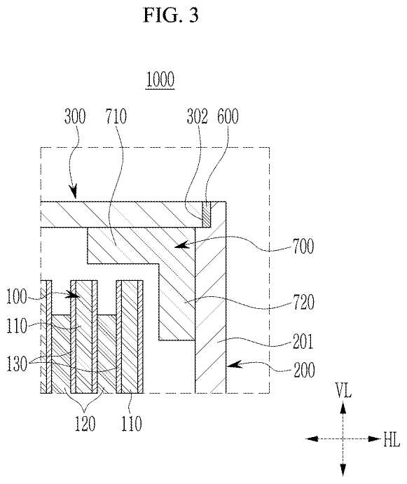

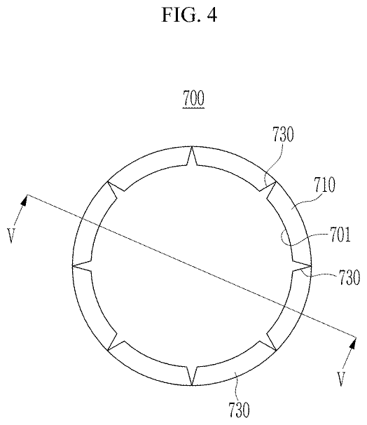

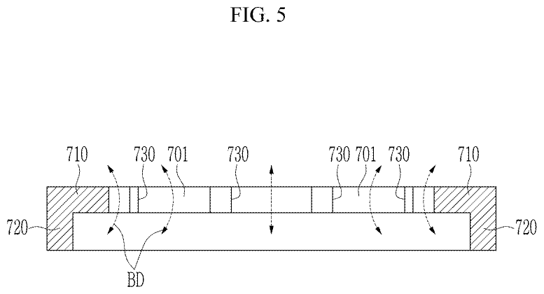

FIG. 3 illustrates an enlarged view of the region A in FIG. 2. FIG. 4 illustrates a top plane view of an annular gasket according to an embodiment. FIG. 5 illustrates a cross-sectional view taken along the line V-V in FIG. 4.

Referring to FIG. 3 to FIG. 5, the annular gasket 700 has a first extension 710, a second extension 720, and a plurality of cut portions 730.

The first extension 710 is positioned between an upper surface of the electrode assembly 100 and the edge 302 of the cap plate 300. The first extension 710 extends along one horizontal line HL crossing (e.g., intersecting) the one vertical line VL and is between the electrode assembly 100 and the cap plate 300.

The second extension 720 is curved and extends in the vertical direction from the first extension 710, which extends in the horizontal direction. The second extension 720 is positioned between the sidewall 201 of the case 200 and the side surface of the electrode assembly 100. The second extension 720 extends along (e.g., extend parallel to) one vertical line VL and is between the electrode assembly 100 and the case 200.

Referring to FIG. 4 and FIG. 5, the cut portions 730 are spaced apart from each other along the inner edge 701 of the annular gasket 700. The cut portions 730 are positioned in the first extension 710 and are spaced apart from each other along the first extension 710 extending in an annular shape in a plane view. The cut portions 730 are cut portions, and each of the cut portions 730 has a triangular shape in a plane view.

Referring to FIG. 5, cut portions 730 are positioned spaced apart from each other along the inner edge 701 of the first extension 710 of the annular gasket 700 so that the first extension 710 of the annular gasket 700 is easily bent (BD) in the vertical direction.

Referring to FIG. 5 and FIG. 2, because the first extension 710 of the annular gasket 700 is easily bent (BD) in the vertical direction, when the electrode assembly 100 is accommodated into the case 200 through the opening 210 in the case 200 during a manufacturing process of the button cell 1000, even when the first extension 710 of the annular gasket 700 interferes with the electrode assembly 100, the first extension 710 of the annular gasket 700 is bent along the moving direction of the electrode assembly 100 so that the electrode assembly 100 is easily accommodated inside the case 200 through the opening 210.

In addition, because the first extension 710 of the annular gasket 700 is easily bent (BD) in the vertical direction, when welding the second electrode tab 150 to the protrusion 420 of the terminal plate 400 during the manufacturing process of the button cell 1000, even when the first extension 710 of the annular gasket 700 interferes with the second electrode tab 150, the first extension 710 of the annular gasket 700 is bent along the moving direction of the second electrode tab 150 so that the second electrode tab 150 is easily welded to the protrusion 420 of the terminal plate 400 through the opening 210.

As such, in the button cell 1000 according to an embodiment, the annular gasket 700 is positioned between the electrode assembly 100 and the edge 302 of the cap plate 300 and between the electrode assembly 100 and the sidewall 201 of the case 200 inside the case 200 to correspond to the annular welded portion 600, and thus, when the annular welded portion 600 is formed between the sidewall 201 of the case 200 and the edge 302 of the cap plate 300 by a welding process for coupling the case 200 and the cap plate 300, welding heat generated in the annular welded portion 600 is blocked by the annular gasket 700 and a short circuit between the first electrode 110 and the second electrode 120 is prevented because the separator 130 in the electrode assembly 100 accommodated inside the case 200 is not melted by the welding heat.

In addition, in the button cell 1000 according to an embodiment, the annular gasket 700 is positioned between the electrode assembly 100 and the edge 302 of the cap plate 300 and between the electrode assembly 100 and the sidewall 201 of the case 200 inside the case 200 to correspond to the annular welded portion 600, and when the annular gasket 700 contacts and supports a corner between upper and side surfaces of the electrode assembly 100, damage to each of the first electrode 110, the second electrode 120, the separator 130, the first electrode tab 140, and the second electrode tab 150 of the electrode assembly 100 due to an impact applied to the electrode assembly 100 is suppressed by suppressing up and down movement and left and right movement of the electrode assembly 100.

For example, the annular gasket 700 not only suppresses melting of the separator 130 of the electrode assembly 100 due to the welding heat generated between the case 200 and the cap plate 300 but also suppresses movement of the electrode assembly 100.

In addition, in the button cell 1000 according to an embodiment, the first extension 710 of the annular gasket 700 is easily bent (BD) in the vertical direction due to the cut portions 730, and when the electrode assembly 100 is accommodated into the case 200 through the opening 210 in the case 200 during a manufacturing process of the button cell 1000, even if the first extension 710 of the annular gasket 700 interferes with the electrode assembly 100, the first extension 710 of the annular gasket 700 bends along the moving direction of the electrode assembly 100 so that the electrode assembly 100 is easily accommodated inside the case 200 through the opening 210.

In addition, in the button cell 1000 according to an embodiment, because the first extension 710 of the annular gasket 700 is easily bent (BD) in the vertical direction, when welding the second electrode tab 150 to the protrusion 420 of the terminal plate 400 during the manufacturing process of the button cell 1000, even if the first extension 710 of the annular gasket 700 interferes with the second electrode tab 150, the first extension 710 of the annular gasket 700 bends along the moving direction of the second electrode tab 150 so that the second electrode tab 150 is easily welded to the protrusion 420 of the terminal plate 400.

For example, the button cell 1000 provides easy accommodation of the electrode assembly 100 into the case 200 even when the annular gasket 700 is included.

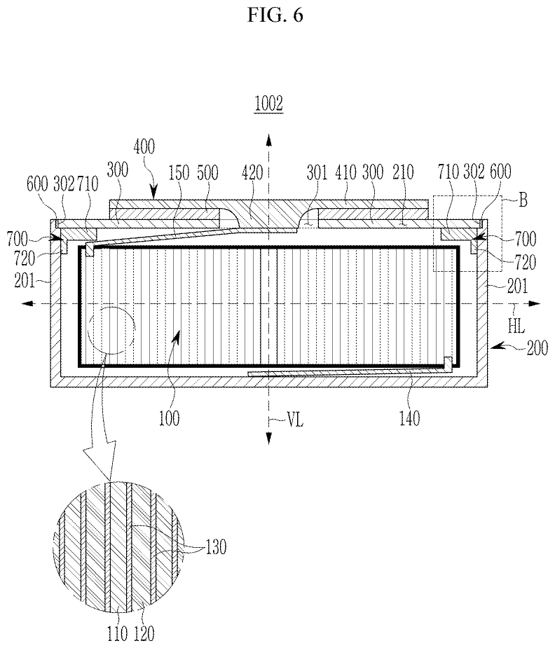

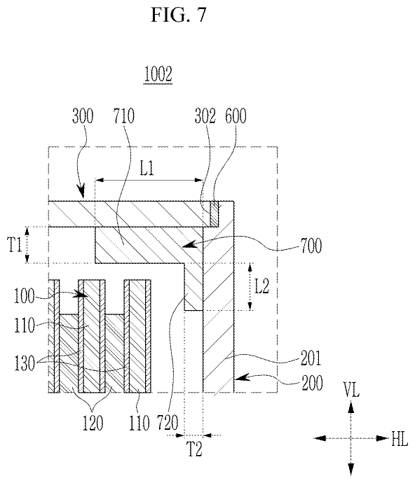

Hereinafter, a button cell according to another embodiment will be described with reference to FIG. 6 and FIG. 7.

Aspects and features of the button cell according to another embodiment that differ from the above-described embodiments will be primarily described.

FIG. 6 illustrates a cross-sectional view of a button cell according to another embodiment, and FIG. 7 illustrates an enlarged view of the region B in FIG. 6.

Referring to FIG. 6 and FIG. 7, an annular gasket 700 of a button cell 1002 according to another embodiment includes a first extension 710, a second extension 720, and a plurality of cut portions. Herein, the cut portions may have same positions and shapes as those of the plurality of cut portions 730 in the annular gasket 700 according to the above-described embodiment.

The first extension 710 is positioned between an upper surface of the electrode assembly 100 and the edge 302 of the cap plate 300. The first extension 710 extends along one horizontal line HL crossing (e.g., intersecting) one vertical line VL and is between the electrode assembly 100 and the cap plate 300.

The second extension 720 is curved and extends in the vertical direction from the first extension 710 extending in the horizontal direction. The second extension 720 is positioned between the sidewall 201 of the case 200 and the side surface of the electrode assembly 100. The second extension 720 extends along (e.g., is parallel to) one vertical line VL and is between the electrode assembly 100 and the case 200.

The second extension 720 has a thinner thickness than that of the first extension 710 and a shorter length than that of the first extension 710. For example, a second thickness T2 of the second extension 720 is thinner than a first thickness T1 of the first extension 710, and a second length L2 of the second extension 720 is shorter than a first length L1 of the first extension 710.

The second extension 720 overlaps the first electrode 110, which is an anode, in the direction of the one horizontal line HL crossing one vertical line VL, and does not overlap the second electrode 120, which is a cathode. The second extension 720 overlaps only the first electrode 110. When the annular gasket 700 contacts the electrode assembly 100, the second extension 720 only contacts the first electrode 110, and the second extension 720 does not contact the second electrode 120.

As such, the button cell 1002 includes the annular gasket 700 that not only suppresses melting of the separator 130 of the electrode assembly 100 due to welding heat between the case 200 and the cap plate 300 but also suppresses the movement of the electrode assembly 100.

In addition, in the button cell 1002, the first extension 710 of the annular gasket 700 is easily bent in the vertical direction due to the cut portions when the electrode assembly 100 is accommodated into the case 200 through the opening 210 in the case 200 during a manufacturing process of the button cell 1000. Even if the first extension 710 of the annular gasket 700 interferes with the electrode assembly 100, the first extension 710 of the annular gasket 700 bends along the moving direction of the electrode assembly 100 so that the electrode assembly 100 is easily accommodated inside the case 200 through the opening 210.

In addition, in the button cell 1002, because the first extension 710 of the annular gasket 700 is easily bent in the vertical direction, when welding the second electrode tab 150 to the protrusion 420 of the terminal plate 400 during the manufacturing process of the button cell 1002, even if the first extension 710 of the annular gasket 700 interferes with the second electrode tab 150, the first extension 710 of the annular gasket 700 bends along the moving direction of the second electrode tab 150 so that the second electrode tab 150 is easily welded to the protrusion 420 of the terminal plate 400 through the opening 210.

In addition, in the button cell 1002, the second extension 720 of the annular gasket 700 is not only thinner than the first extension 710 and shorter in length than the first extension 710 but also overlaps the first electrode 110, which is an anode, in the direction of one horizontal line HL and does not overlap the second electrode 120, which is a cathode, in the direction of one horizontal line HL, thereby reducing or minimizing a decrease in battery capacity due to a space where the annular gasket 700 is positioned.

For example, the button cell 1002 easily accommodates the electrode assembly 100 into the case 200 even when the annular gasket 700 is included while also reducing or minimizing battery capacity deterioration.

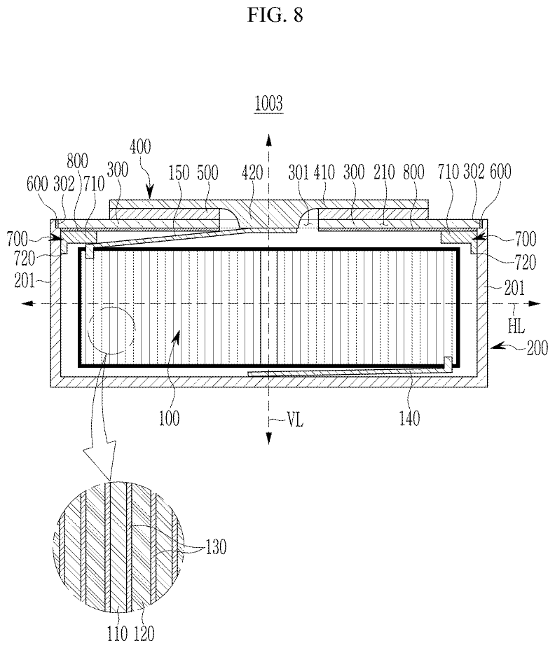

Hereinafter, a button cell according to another embodiment will be described with reference to FIG. 8.

Aspects and features of the button cell according to another embodiment that differ from the above-described embodiments will be primarily described.

FIG. 8 illustrates a cross-sectional view showing a button cell according to another embodiment.

Referring to FIG. 8, a button cell 1003 according to another embodiment includes an electrode assembly 100, a case 200, a cap plate 300, a terminal plate 400, a bonding layer 500, a ring (or annular) welded portion 600, an annular gasket 700, and an insulating washer 800.

The insulating washer 800 is positioned between the annular gasket 700 and the cap plate 300. The insulation washer 800 is positioned over an entire rear surface (e.g., inner or bottom surface) of the cap plate 300 positioned opposite to a front surface of the cap plate 300 bonded to the bonding layer 500. The annular gasket 700 is positioned between the insulating washer 800 and the electrode assembly 100 inside the case 200. The insulating washer 800 is positioned between the annular gasket 700 and the annular welded portion 600. The insulation washer 800 may include various known insulation materials, such as a polyimide and polypropylene.

As such, in the button cell 1003, because the insulation washer 800 and the annular gasket 700 are positioned between the annular weld 600 and the electrode assembly 100 inside the case 200 and correspond to the annular weld 600, the separator 130 of the electrode assembly 100 is not melted by welding heat between the case 200 and the cap plate 300 and a movement of the electrode assembly 100 is suppressed.

In addition, in the button cell 1003, because the first extension 710 of the annular gasket 700 is easily bent in the vertical direction by a plurality of cut portions, and when the electrode assembly 100 is accommodated into the case 200 through the opening 210 in the case 200 during a manufacturing process of the button cell 1003, even if the first extension 710 of the annular gasket 700 interferes with the electrode assembly 100, the first extension 710 of the annular gasket 700 bends along the moving direction of the electrode assembly 100 so that the electrode assembly 100 is easily accommodated inside the case 200 through the opening 210.

In addition, in the button cell 1003, because the first extension 710 of the annular gasket 700 is easily bent in the vertical direction, when welding the second electrode tab 150 to the protrusion 420 of the terminal plate 400 during the manufacturing process of the button cell 1003, even if the first extension 710 of the annular gasket 700 interferes with the second electrode tab 150, the first extension 710 of the annular gasket 700 bends along the moving direction of the second electrode tab 150 so that the second electrode tab 150 is easily welded to the protrusion 420 of the terminal plate 400 through the opening 210.

In addition, in the button cell 1003, because the insulation washer 800 is positioned over the entire rear surface of the cap plate 300, a short circuit between the second electrode tab 150 and the cap plate 300 is suppressed.

In addition, in the button cell 1003, the second extension 720 of the annular gasket 700 is not only thinner than the first extension 710 and shorter in length than the first extension 710 but also overlaps the first electrode 110, which is an anode, in the direction of one horizontal line HL and does not overlap with the second electrode 120, which is a cathode, in the direction of one horizontal line HL, thereby reducing or minimizing decrease in battery capacity due to a space where the annular gasket 700 is positioned.

For example, the button cell 1003 easily accommodates the electrode assembly 100 into the case 200 even when including the annular gasket 700 and the insulating washer 800 that not only suppresses melting of the separator 130 of the electrode assembly 100 due to welding heat between the case 200 and the cap plate 300 but also suppresses the movement of the electrode assembly 100 and reduces or minimizes battery capacity deterioration.

While the present disclosure has been described in connection with what is presently considered to be practical embodiments, it is to be understood that the present disclosure is not limited to the disclosed embodiments. The present disclosure is intended to cover various modifications and equivalent arrangements included within the spirit and scope of the appended claims and their equivalents.

### DESCRIPTION OF SOME REFERENCE SYMBOLS

100 electrode assembly
200 case
300 cap plate
400 terminal plate
500 bonding layer
600 annular welded portion
700 annular gasket

What is claimed is:

1. A button cell comprising:
an electrode assembly comprising a first electrode, a second electrode, and a separator between the first electrode and the second electrode;
a case accommodating the electrode assembly, electrically connected to the first electrode, and having an opening exposing the electrode assembly;
a cap plate coupled to the case at an outer periphery of the opening and having a through hole exposing a central area of the opening;
a terminal plate connected to the second electrode, insulatively bonded to the cap plate, and covering the through hole;
an annular welded portion connecting an edge of the cap plate and a sidewall of the case; and
an annular gasket inside the case, corresponding to the annular welded portion, and between the electrode assembly and the edge of the cap plate and between the electrode assembly and a sidewall of the case, the annular gasket having a plurality of cut portions spaced apart from each other along an inner edge thereof.

2. The button cell of claim 1, wherein each of the cut portions in the annular gasket has a triangular shape.

3. The button cell of claim 1, wherein the annular gasket has:
a first extension between an upper surface of the electrode assembly and the edge of the cap plate; and
a second extension extending from the first extension and being between a side surface of the electrode assembly and the sidewall of the case.

4. The button cell of claim 3, wherein the cut portions are in the first extension.

5. The button cell of claim 3, wherein the second extension is thinner than the first extension.

6. The button cell of claim 3, wherein the second extension is shorter than the first extension.

7. The button cell of claim 3, wherein the electrode assembly is wound about a winding axis to have a jelly roll shape, and
wherein the first electrode protrudes closer to the cap plate than the second electrode is.

8. The button cell of claim 7, wherein the second extension overlaps the first electrode in a horizontal direction crossing the winding axis and does not overlap the second electrode.

9. The button cell of claim 8, wherein the first electrode is an anode, and the second electrode is a cathode.

10. The button cell of claim 1, further comprising an insulating washer between the annular gasket and the cap plate.

11. The button cell of claim 10, wherein the insulating washer extends over an entire rear surface of the cap plate.

12. The button cell of claim 1, further comprising a bonding layer between the cap plate and the terminal plate to insulatively bond the cap plate and the terminal plate.

13. The button cell of claim 12, wherein the terminal plate has:
a flange portion covering the through hole in the cap plate and contacting the bonding layer; and
a protrusion extending from the flange portion through the through hole in the cap plate.

14. The button cell of claim 13, wherein the electrode assembly comprises:
a first electrode tab extending from the first electrode and welded to the case; and
a second electrode tab extending from the second electrode and welded to the protrusion of the terminal plate.

15. The button cell of claim 1, wherein the case and the cap plate have the same polarity as that of the first electrode, and
wherein the terminal plate has the same polarity as that of the second electrode.

16. The button cell of claim 1, wherein a ratio of a height to a diameter of the button cell is 1 or less.
